(19) United States
(12) Patent Application Publication
(10) Pub. No.: US 2020/0242779 A1
(43) Pub. Date: Jul. 30, 2020

(54) SYSTEMS AND METHODS FOR EXTRACTING A SURFACE NORMAL FROM A DEPTH IMAGE

(71) Applicant: QUALCOMM Incorporated, San Diego, CA (US)

(72) Inventors: Yan Deng, San Diego, CA (US); Michel Adib Sarkis, San Diego, CA (US); Yingyong Qi, San Diego, CA (US)

(21) Appl. No.: 16/262,516

(22) Filed: Jan. 30, 2019

(51) Int. Cl. G06T 7/194; G06T 7/50; H04N 5/232

(52) U.S. Cl. CPC G06T 7/194; G06T 2207/10028; H04N 5/23229; G06T 7/50

(57) ABSTRACT

A method performed by an electronic device is described. The method includes obtaining a two-dimensional (2D) depth image. The method also includes extracting a 2D subset of the depth image. The 2D subset includes a center pixel and a set of neighboring pixels. The method further includes calculating a normal corresponding to the center pixel by calculating a covariance matrix based on the 2D subset.

### FIELD OF DISCLOSURE

The present disclosure relates generally to electronic devices. More specifically, the present disclosure relates to systems and methods for extracting a surface normal from a depth image.

### BACKGROUND

Some electronic devices (e.g., cameras, video camcorders, digital cameras, cellular phones, smart phones, computers, televisions, automobiles, personal cameras, wearable cameras, virtual reality devices (e.g., headsets), augmented reality devices (e.g., headsets), mixed reality devices, action cameras, surveillance cameras, mounted cameras, connected cameras, robots, drones, healthcare equipment, set-top boxes, etc.) capture and/or utilize sensor data. For example, a smart phone may capture and/or process still and/or video images. Processing sensor data may demand a relatively large amount of time, memory, and energy resources. The resources demanded may vary in accordance with the complexity of the processing.

In some cases, processing sensor data may consume a large amount of resources. As can be observed from this discussion, systems and methods that improve sensor data processing may be beneficial.

### SUMMARY

A method performed by an electronic device is described. The method includes obtaining a two-dimensional (2D) depth image. The method also includes extracting a 2D subset of the depth image. The 2D subset includes a center pixel and a set of neighboring pixels. The method further includes calculating a normal corresponding to the center pixel by calculating a covariance matrix based on the 2D subset.

The method may include removing one or more background pixels from the 2D subset to produce a trimmed 2D subset. The normal may be calculated based on the trimmed 2D subset. Calculating the normal may include performing sharpening by calculating a difference between a neighboring pixel value and a center pixel value and calculating the covariance matrix based on the difference. Calculating the covariance matrix may be based on the difference and a transpose of the difference.

Calculating the normal corresponding to the center pixel may include determining an eigenvector of the covariance matrix. The eigenvector may be associated with a smallest eigenvalue of the covariance matrix. Calculating the normal corresponding to the center pixel may include lifting the 2D subset into a three-dimensional (3D) space.

The method may include extracting a set of 2D subsets of the depth image that includes the 2D subset. The set of 2D subsets may correspond to foreground pixels of the depth image. The method may include calculating a set of normals corresponding to the set of 2D subsets. A time complexity of extracting the set of 2D subsets and calculating the set of normals may be on an order of a number of the 2D subsets multiplied by a time complexity of calculating an eigenvector.

The method may include generating a surface based on the normal corresponding to the center pixel. The method may include registering the 2D depth image with a second depth image based on the normal corresponding to the center pixel.

An electronic device is also described. The electronic device includes a memory. The electronic device also includes a processor coupled to the memory. The processor is configured to obtain a two-dimensional (2D) depth image. The processor is also configured to extract a 2D subset of the depth image. The 2D subset includes a center pixel and a set of neighboring pixels. The processor is further configured to calculate a normal corresponding to the center pixel by calculating a covariance matrix based on the 2D subset.

A non-transitory tangible computer-readable medium storing computer executable code is also described. The computer-readable medium includes code for causing an electronic device to obtain a two-dimensional (2D) depth image. The computer-readable medium also includes code for causing the electronic device to extract a 2D subset of the depth image. The 2D subset includes a center pixel and a set of neighboring pixels. The computer-readable medium further includes code for causing the electronic device to calculate a normal corresponding to the center pixel by calculating a covariance matrix based on the 2D subset.

An apparatus is also described. The apparatus includes means for obtaining a two-dimensional (2D) depth image. The apparatus also includes means for extracting a 2D subset of the depth image. The 2D subset includes a center pixel and a set of neighboring pixels. The apparatus further includes means for calculating a normal corresponding to the center pixel by calculating a covariance matrix based on the 2D subset.

### BRIEF DESCRIPTION OF THE DRAWINGS

FIG. 1 is a block diagram illustrating one example of an electronic device in which systems and methods for extracting a surface normal from a depth image may be implemented;

FIG. 2 is a flow diagram illustrating one configuration of a method for extracting a surface normal from a depth image;

FIG. 3 is a diagram illustrating an example of two-dimensional (2D) subset of a depth image;

FIG. 4 is a flow diagram illustrating one configuration of another method for extracting a surface normal from a depth image;

FIG. 5 is a diagram illustrating another example of 2D subset of a depth image;

FIG. 6 is a flow diagram illustrating another configuration of a method for extracting a surface normal from a depth image;

FIG. 7 is a flow diagram illustrating another configuration of a method for extracting a surface normal from a depth image;

FIG. 8 is a flow diagram illustrating another configuration of a method for extracting a surface normal from a depth image;

FIG. 9 is a diagram illustrating an example of a depth image visualization and a surface normal visualization; and

FIG. 10 illustrates certain components that may be included within an electronic device configured to implement various configurations of the systems and methods disclosed herein.

### DETAILED DESCRIPTION

Some configurations of the systems and methods disclosed herein may relate to fast surface normal extraction from a depth image. As used herein, a “normal” is a vector or an estimate of a vector that is perpendicular to a surface or plane. A “surface normal” is an estimate of a vector that is perpendicular to a surface. A depth image may be a two-dimensional (2D) set of depth values. For example, a depth sensor may capture a depth image by determining a distance between the depth sensor and the surface of one or more objects in an environment for a set of pixels. A surface normal may be estimated as a vector that is perpendicular to the surface. The surface normal may be utilized in computer vision, to render a representation of the surface (e.g., render a surface represented by the depth image), and/or to register depth images (e.g., register surfaces represented by the depth images), etc. One problem with extracting a surface normal is the time complexity and/or load utilized to determine the surface normal.

In some approaches, a surface normal may be calculated from a depth image as follows. A three-dimensional (3D) point cloud may be extracted from a depth image. For each point in the 3D point cloud, a local neighborhood is extracted via searching a k-dimensional (k-d) tree of the point cloud. A k-d tree is a data structure that organizes points in a space, where the points correspond to leaf nodes and non-leaf nodes of the tree represent divisions of the space. The local neighborhood may be extracted by searching the k-d tree for nearest neighbors. Then, a local plane may be fitted to the local neighborhood. Fitting a plane may include determining a plane corresponding to data. For example, fitting a plane to the local neighborhood may include determining a plane that minimizes a squared error between the plane and the points in the local neighborhood (e.g., a plane that best “fits” the points in the local neighborhood). The local plane may be utilized to find the normal of the surface or an average of the cross-products of local tangent vectors may be taken to find the normal of the surface. In these approaches, the time complexity may be expressed in big O notation as O(N log N+NM^{ω}), where N is a number of points in the 3D point cloud, M is a number of points in each local neighborhood, ω is a constant number, and M^{ω} is a time complexity to compute the normal via eigen decomposition. Eigen decomposition is a factorization of a matrix into eigenvalues and eigenvectors. In an example, QR decomposition is an algorithm that may be utilized to compute the eigen decomposition, where QR decomposition has a time complexity where ω is a constant number between 2 and 3. Other approaches may be utilized to compute the eigen decomposition. For example, the complexity of eigen decomposition may be related to the complexity of the algorithm utilized and the data utilized. For instance, depending on the algorithm utilized and the data type (e.g., whether the data matrix can be diagonalized or not), ω may vary between 2 and 3. One portion of the time complexity (denoted N log N) is due to extracting local neighborhoods from the 3D point cloud. Accordingly, one problem with this approach is that the local neighborhood extraction (e.g., the k-d searching) adds time complexity, which slows the surface normal calculation and/or consumes more processing resources.

In some approaches, calculating the surface normal may be performed from a gradient of the depth image as follows. A tangent vector may be calculated via two directional derivatives. Then, the surface normal may be calculated as the cross product of the two directional derivative vectors. One problem with this approach is that the surface normal calculated may not be accurate in comparison with other approaches, as it may be based on a single cross product rather than an average of cross products.

Some configurations of the systems and methods disclosed herein may address one or more of these problems. For example, some configurations of the systems and methods disclosed herein may provide improved speed and/or accuracy of a surface normal calculation. In some configurations, the systems and methods disclosed herein may provide improved speed and/or accuracy in generating (e.g., rendering) a surface and/or registering depth images. Accordingly, some configurations of the systems and methods disclosed herein improve the functioning of computing devices (e.g., computers) themselves by improving the speed at which computing devices are able to calculate a surface normal and/or by improving the accuracy with which computing devices are able to calculate a surface normal. Additionally or alternatively, some configurations of the systems and methods disclosed herein may provide improvements to various technologies and technical fields, such as automated environmental modeling, automated environmental navigation, scene rendering, and/or measurement fusion. In some configurations, the systems and methods disclosed herein may extract an accurate normal with improved speed. In some configurations, a local neighborhood may be extracted via a 2D depth image and a local plane may be fitted. The surface normal may be estimated as the normal of the local plane. In some configurations, a mask based trimmed window may be used along an object boundary to avoid error introduced by the background.

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

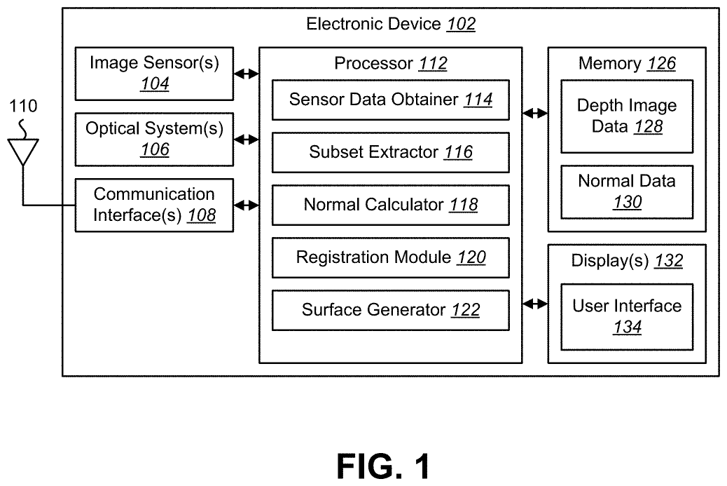

FIG. 1 is a block diagram illustrating one example of an electronic device 102 in which systems and methods for extracting a surface normal from a depth image may be implemented. Examples of the electronic device 102 include cameras, video camcorders, digital cameras, cellular phones, smartphones, tablet devices, personal cameras, wearable cameras, virtual reality devices (e.g., headsets), augmented reality devices (e.g., headsets), mixed reality devices, action cameras, surveillance cameras, mounted cameras, connected cameras, vehicles (e.g., semi-autonomous vehicles, autonomous vehicles, etc.), automobiles, robots, aircraft, drones, unmanned aerial vehicles (UAVs), servers, computers (e.g., desktop computers, laptop computers, etc.), network devices, healthcare equipment, gaming consoles, appliances, etc. In some configurations, the electronic device 102 may be integrated into one or more devices (e.g., vehicles, drones, mobile devices, etc.). The electronic device 102 may include one or more components or elements. One or more of the components or elements may be implemented in hardware (e.g., circuitry), a combination of hardware and software (e.g., a processor with instructions), and/or a combination of hardware and firmware.

In some configurations, the electronic device 102 may include a processor 112, a memory 126, one or more displays 132, one or more image sensors 104, one or more optical systems 106, and/or one or more communication interfaces 108. The processor 112 may be coupled to (e.g., in electronic communication with) the memory 126, display(s) 132, image sensor(s) 104, optical system(s) 106, and/or communication interface(s) 108. It should be noted that one or more of the elements illustrated in FIG. 1 may be omitted in some configurations. In particular, the electronic device 102 may not include one or more of the elements illustrated in FIG. 1 in some configurations. For example, the electronic device 102 may or may not include an image sensor 104 and/or optical system 106. Additionally or alternatively, the electronic device 102 may or may not include a display 132. Additionally or alternatively, the electronic device 102 may or may not include a communication interface 108.

In some configurations, the electronic device 102 may be configured to perform one or more of the functions, procedures, methods, steps, etc., described in connection with one or more of FIGS. 1-10. Additionally or alternatively, the electronic device 102 may include one or more of the structures described in connection with one or more of FIGS. 1-10.

The memory 126 may store instructions and/or data. The processor 112 may access (e.g., read from and/or write to) the memory 126. Examples of instructions and/or data that may be stored by the memory 126 may include depth image data 128 (e.g., depth images, 2D arrays of depth measurements, etc.), normal data 130 (e.g., surface normal data, vector data indicating surface normals, etc.), sensor data obtainer 114 instructions, subset extractor 116 instructions, normal calculator 118 instructions, registration module 120 instructions, surface generator 122 instructions, and/or instructions for other elements, etc.

The communication interface 108 may enable the electronic device 102 to communicate with one or more other electronic devices. For example, the communication interface 108 may provide an interface for wired and/or wireless communications. In some configurations, the communication interface 108 may be coupled to one or more antennas 110 for transmitting and/or receiving radio frequency (RF) signals. For example, the communication interface 108 may enable one or more kinds of wireless (e.g., cellular, wireless local area network (WLAN), personal area network (PAN), etc.) communication. Additionally or alternatively, the communication interface 108 may enable one or more kinds of cable and/or wireline (e.g., Universal Serial Bus (USB), Ethernet, High Definition Multimedia Interface (HDMI), fiber optic cable, etc.) communication.

In some configurations, multiple communication interfaces 108 may be implemented and/or utilized. For example, one communication interface 108 may be a cellular (e.g., 3G, Long Term Evolution (LTE), Code-Division Multiple Access (CDMA), etc.) communication interface 108, another communication interface 108 may be an Ethernet interface, another communication interface 108 may be a universal serial bus (USB) interface, and yet another communication interface 108 may be a wireless local area network (WLAN) interface (e.g., Institute of Electrical and Electronics Engineers (IEEE) 802.11 interface). In some configurations, the communication interface(s) 108 may send information (e.g., normal data 130) to and/or receive information (e.g., depth image data 128) from another electronic device (e.g., a vehicle, a smart phone, a camera, a display, a robot, a remote server, etc.).

In some configurations, the electronic device 102 (e.g., sensor data obtainer 114) may obtain (e.g., receive) one or more frames (e.g., image frames, video, and/or depth image frames, etc.). The one or more frames may indicate data captured from an environment (e.g., one or more objects and/or background).

In some configurations, the electronic device 102 may include one or more image sensors 104 and/or one or more optical systems 106 (e.g., lenses). An optical system 106 may focus images of objects that are located within the field of view of the optical system 106 onto an image sensor 104. The optical system(s) 106 may be coupled to and/or controlled by the processor 112 in some configurations. The one or more image sensor(s) 104 may be used in conjunction with the optical system(s) 106 or without the optical system(s) 106 depending on the implementation. In some implementations, the electronic device 102 may include a single image sensor 104 and/or a single optical system 106. For example, a single depth camera with a particular resolution at a particular frame rate (e.g., 30 frames per second (fps), 60 fps, 120 fps, etc.) may be utilized. In other implementations, the electronic device 102 may include multiple optical system(s) 106 and/or multiple image sensors 104. For example, the electronic device 102 may include two or more lenses in some configurations. The lenses may have the same focal length or different focal lengths.

In some examples, the image sensor(s) 104 and/or the optical system(s) 106 may be mechanically coupled to the electronic device 102 or to a remote electronic device (e.g., may be attached to, mounted on, and/or integrated into the body of a vehicle, the hood of a car, a rear-view mirror mount, a side-view mirror, a bumper, etc., and/or may be integrated into a smart phone or another device, etc.). The image sensor(s) 104 and/or optical system(s) 106 may be linked to the electronic device 102 via a wired and/or wireless link in some configurations.

Examples of image sensor(s) 104 may include optical image sensors, depth image sensors, red-green-blue-depth (RGBD) sensors, etc. For example, the electronic device 102 may include one or more depth sensors (e.g., time-of-flight cameras, lidar sensors, etc.) and/or optical sensors (e.g., two-dimensional (2D) image sensors, 3D image sensors, etc.). The image sensor(s) 104 may capture one or more image frames (e.g., optical image frames, depth image frames, optical/depth frames, etc.). As used herein, the term “optical” may denote visual spectrum information. For example, an optical sensor may sense visual spectrum data. As used herein, the term “depth” may denote a distance between a depth sensor and an object. For example, a depth sensor may sense depth data (e.g., one or more distances between the depth sensor and an object). In some configurations, the depth image data 128 may include depth data (e.g., distance measurements) associated with one or more times or time ranges. For example, a “frame” may correspond to an instant of time or a range of time in which data corresponding to the frame is captured. Different frames may be separate or overlapping in time. Frames may be captured at regular periods, semi-regular periods, or aperiodically.

In some implementations, the electronic device 102 may include multiple optical system(s) 106 and/or multiple image sensors 104. Different lenses may each be paired with separate image sensors 104 in some configurations. Additionally or alternatively, two or more lenses may share the same image sensor 104. In some configurations, an image sensor 104 (e.g., depth image sensor) may not be paired with a lens and/or optical system(s) 106 may not be included in the electronic device 102. It should be noted that one or more other types of sensors may be included and/or utilized to produce frames in addition to or alternatively from the image sensor(s) 104 in some implementations.

In some configurations, a camera may include at least one sensor and at least one optical system. Accordingly, the electronic device 102 may be one or more cameras, may include one or more cameras, and/or may be coupled to one or more cameras in some implementations.

In some configurations, the electronic device 102 may request and/or receive the one or more depth images from another device (e.g., one or more external sensors coupled to the electronic device 102). In some configurations, the electronic device 102 may request and/or receive the one or more depth images via the communication interface 108. For example, the electronic device 102 may or may not include an image sensor 104 and may receive frames (e.g., optical image frames, depth image frames, etc.) from one or more remote devices.

The electronic device may include one or more displays 132. The display(s) 132 may present optical content (e.g., one or more image frames, video, still images, graphics, virtual environments, three-dimensional (3D) image content, 3D models, symbols, characters, etc.). The display(s) 132 may be implemented with one or more display technologies (e.g., liquid crystal display (LCD), organic light-emitting diode (OLED), plasma, cathode ray tube (CRT), etc.). The display(s) 132 may be integrated into the electronic device 102 or may be coupled to the electronic device 102. For example, the electronic device 102 may be a virtual reality headset with integrated displays 132. In another example, the electronic device 102 may be a computer that is coupled to a virtual reality headset with the displays 132. In some configurations, the content described herein (e.g., surfaces, depth image data, frames, 3D models, etc.) or a visualization thereof may be presented on the display(s) 132. For example, the display(s) 132 may present an image depicting a surface and/or 3D model of an environment (e.g., one or more objects). In some configurations, all or portions of the frames that are being captured by the image sensor(s) 104 may be presented on the display 132. Additionally or alternatively, one or more representative images (e.g., icons, cursors, virtual reality images, augmented reality images, etc.) may be presented on the display 132.

In some configurations, the electronic device 102 may present a user interface 134 on the display 132. For example, the user interface 134 may enable a user to interact with the electronic device 102. In some configurations, the display 132 may be a touchscreen that receives input from physical touch (by a finger, stylus, or other tool, for example). Additionally or alternatively, the electronic device 102 may include or be coupled to another input interface. For example, the electronic device 102 may include a camera and may detect user gestures (e.g., hand gestures, arm gestures, eye tracking, eyelid blink, etc.). In another example, the electronic device 102 may be linked to a mouse and may detect a mouse click. In yet another example, the electronic device 102 may be linked to one or more other controllers (e.g., game controllers, joy sticks, touch pads, motion sensors, etc.) and may detect input from the one or more controllers.

In some configurations, the electronic device 102 and/or one or more components or elements of the electronic device 102 may be implemented in a headset. For example, the electronic device 102 may be a smartphone mounted in a headset frame. In another example, the electronic device 102 may be a headset with integrated display(s) 132. In yet another example, the display(s) 132 may be mounted in a headset that is coupled to the electronic device 102.

In some configurations, the electronic device 102 may be linked to (e.g., communicate with) a remote headset. For example, the electronic device 102 may send information to and/or receive information from a remote headset. For instance, the electronic device 102 may send information (e.g., depth image data 128, normal data 130, surface information, frame data, one or more images, video, one or more frames, 3D model data, etc.) to the headset and/or may receive information (e.g., captured frames) from the headset.

The processor 112 may include and/or implement a sensor data obtainer 114, a subset extractor 116, a normal calculator 118, a registration module 120, and/or a surface generator 122. It should be noted that one or more of the elements illustrated in the electronic device 102 and/or processor 112 may be omitted in some configurations. For example, the processor 112 may not include and/or implement the registration module 120 and/or the surface generator 122 in some configurations. Additionally or alternatively, one or more of the elements illustrated in the processor 112 may be implemented separately from the processor 112 (e.g., in other circuitry, on another processor, on a separate electronic device, etc.).

The processor 112 may include and/or implement a sensor data obtainer 114. The sensor data obtainer 114 may obtain sensor data from one or more sensors. For example, the sensor data obtainer 114 may obtain (e.g., receive) one or more images (e.g., depth images and/or optical images, etc.). For instance, the sensor data obtainer 114 may receive depth image data 128 from one or more image sensors 104 included in the electronic device 102 and/or from one or more remote image sensors. A depth image may be a two-dimensional (2D) depth image. A 2D depth image may be a 2D array of depths (e.g., distance measurements). For example, a depth image may include a vertical (e.g., height) dimension and a horizontal (e.g., width dimension), where one or more pixels of the depth image includes a depth (e.g., distance measurement) to one or more objects (e.g., 3D objects) in an environment. In some configurations, each pixel of a depth image may indicate a depth (e.g., distance measurement) to an object or a background pixel. A background pixel may have a value (e.g., 0, −1, etc.) indicating that no object was detected (within a distance from the depth sensor, for example). In some configurations, a foreground pixel may be a pixel indicating that an object was detected (within a distance from the depth sensor, for example). For example, a non-zero pixel value of the depth image may indicate a point on a surface observed by the image sensor 104.

The processor 112 may include and/or implement a subset extractor 116. The subset extractor 116 may extract a 2D subset of a depth image. Each 2D subset of the depth image may include a center pixel and a set of neighboring pixels. As used herein, a “center pixel” may or may not be precisely in the center of the 2D subset. For example, a “center pixel” may be a pixel at the center of the 2D subset (e.g., halfway in one or both dimensions of the 2D subset), or may be a pixel offset from (e.g., next to or one or more pixels away from) the center of the 2D subset. Additionally or alternatively, the “center pixel” may be an anchor pixel relative to which the neighboring pixels may be determined. In some configurations, the center pixel may be selected and/or arbitrarily defined at any position of the 2D subset. The 2D subset may be uniform (e.g., rectangular, square, circular, symmetrical, etc.) or non-uniform (e.g., irregular, asymmetrical in one or more dimensions, etc.) in shape. The set of neighboring pixels may include all pixels in the 2D subset besides the center pixel and/or all pixels within a distance from the center pixel (e.g., all pixels within a range of ±1 pixel, ±2 pixels, ±3 pixels, etc., from the center pixel). In some configurations, a 2D subset may be extracted for each pixel in the depth image, for all foreground pixels in the depth image, and/or for another portion of pixels in the depth image. The 2D subset of a center pixel may correspond to a local neighborhood in three dimensions. For example, a three dimensional local neighborhood may be determined directly from the structure of the 2D subset of the 2D depth image (e.g., neighboring coordinate locations in 2D may dictate nearest neighbors in 3D without searching). Accordingly, a local neighborhood may be directly extracted from the 2D depth image as a 2D subset of the 2D depth image. In some configurations, this approach may avoid performing searching of a 3D point cloud for nearest neighbors, and thereby may reduce time complexity for extracting a surface normal.

In some configurations, the 2D subset may be extracted using a sliding window. For example, a sliding window may traverse the depth image (e.g., all pixels of the depth image, all foreground pixels of the depth image, or all pixels in a portion of the depth image). The sliding window at each pixel may include the 2D subset corresponding to that pixel (e.g., center pixel). The size of the sliding window may determine the number of neighboring pixels in each 2D subset. For example, the sliding window may have a range (e.g., ±1 pixel, ±2 pixels, ±3 pixels, etc.) within which the center pixel and the set of neighboring pixels are included.

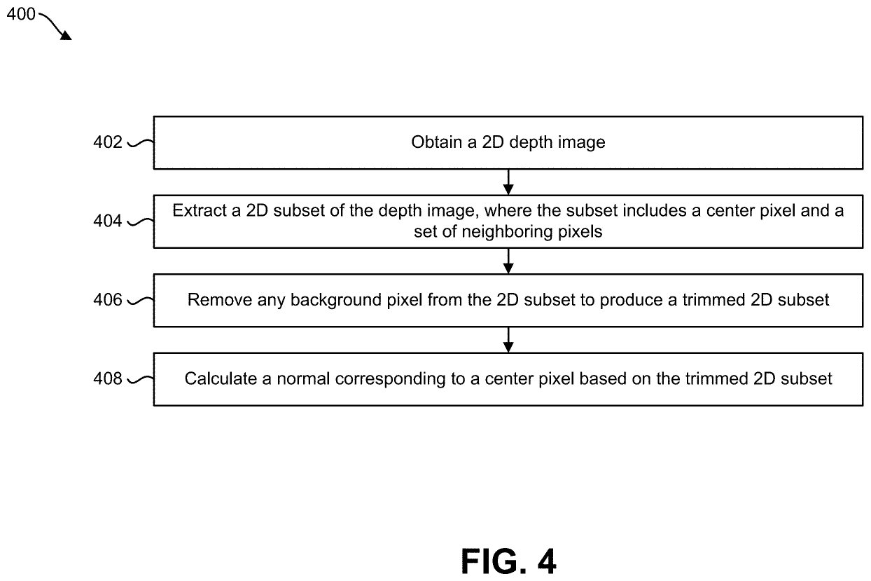

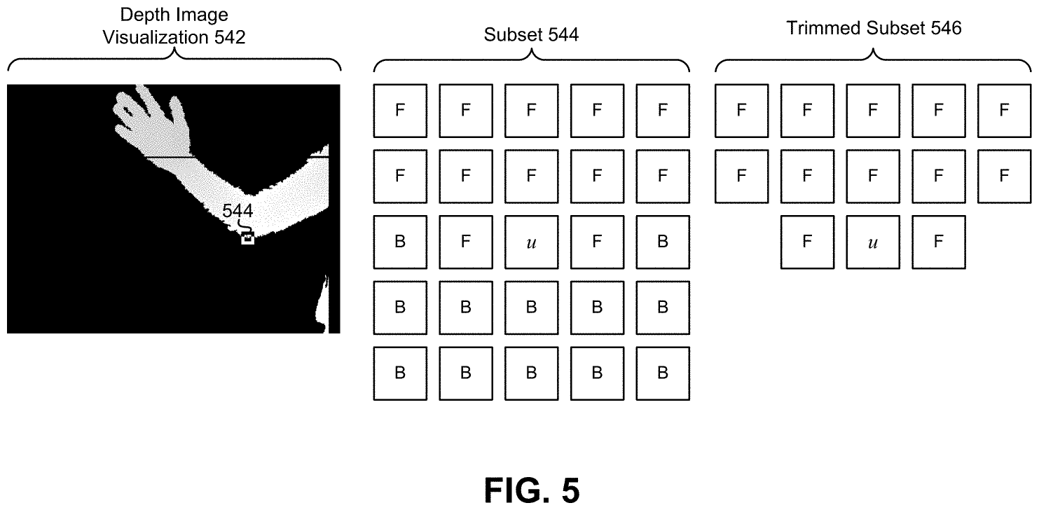

In some configurations, the subset extractor 116 may remove any background pixel from the 2D subset to produce a trimmed 2D subset. The normal may be calculated based on the trimmed 2D subset in some cases and/or configurations. More detail regarding removing background pixels is given in connection with FIGS. 4-5.

The processor 112 may include and/or implement a normal calculator 118. The normal calculator 118 may calculate a normal corresponding to the center pixel based on the 2D subset (or trimmed 2D subset, for example). In some configurations, calculating the normal may include calculating a covariance matrix based on a center pixel value and neighboring pixel values.

A center pixel value may be a pixel value based on the center pixel. An example of the center pixel value may be a pixel value lifted to a 3D space from the center pixel of the 2D subset. As used herein, the term “lift” and variations thereof may denote a mapping or transformation from a space or coordinate system to another space or coordinate system (e.g., from a 2D coordinate system to a 3D coordinate system). A neighboring pixel value may be a pixel value based on a neighboring pixel. An example of the neighboring pixel value may be a pixel value lifted to a 3D space from a neighboring pixel of the 2D subset. An example of a lifting function for lifting a pixel value from a pixel of the 2D subset is given in Equation (1).

$$\prod ( u ) = {[ \frac{( {u}_{x} - {c}_{x} ) D ( u )}{{f}_{x}} , \frac{( {u}_{y} - {c}_{y} ) D ( u )}{{f}_{y}} , D ( u ) ]}^{′} \qquad ( 1 )$$

In Equation (1), Π is the lifting function, u is the center pixel, uₓ is a center pixel position in a first dimension (e.g., x dimension), u_{y} is a center pixel position in a second dimension (e.g., y dimension), cₓ is a principal point offset in the first dimension (e.g., x dimension), c_{y} is a principal point offset in the second dimension (e.g., y dimension), ƒₓ is a focal length in a first dimension (e.g., x dimension), ƒ_{y} is a focal length in a second dimension (e.g., y dimension), D is the depth image, and ′ denotes transpose. The values for cₓ, c_{y}, ƒₓ, and ƒ_{y} may be based on the depth image sensor or depth camera. For example, cₓ, c_{y}, ƒₓ, and ƒ_{y} may correspond to values of an intrinsic matrix for the depth sensor or depth camera.

Equation (2) illustrates an example of a lifting function for a neighboring pixel.

$$\prod ( v ) = {[ \frac{( {v}_{x} - {c}_{x} ) D ( v )}{{f}_{x}} , \frac{( {v}_{y} - {c}_{y} ) D ( v )}{{f}_{y}} , D ( v ) ]}^{′} \qquad ( 2 )$$

In Equation (2), v is a neighboring pixel, vₓ, is a neighboring pixel position in a first dimension (e.g., x dimension), and v_{y} is a neighboring pixel position in a second dimension (e.g., y dimension).

In some examples, the normal calculator 118 may calculate the covariance matrix based on a center pixel value and neighboring pixel values in accordance with Equation (3).

CV=Σ_{v∈η(u)}(Π(v)−Π(u))(Π(v)−Π(u))′ (3)

In Equation (3), CV is the covariance matrix, v is a neighboring pixel, and ƒ(u) is the set of neighboring pixels of center pixel u in the 2D subset. In some configurations, the normal calculator 118 may perform sharpening. For example, sharpening may include calculating a normal from a difference (e.g., subtraction) between a neighboring pixel value and a center pixel value. For instance, the normal calculator 118 may perform sharpening by calculating a difference between a neighboring pixel value and a center pixel value (instead of a difference between a neighboring pixel value and a mean value of all the pixels among the neighborhood, for instance). Some techniques may use an actual mean of the neighborhood as a central point. The normal of that point may be approximated via the normal of the mean point. With those techniques, some detailed curvature may be lost if the overall neighborhood is smooth. In some of the approaches described herein, the current pixel or point may be utilized as a “sharp” point so that the derived normal may be a more accurate (e.g., exact) normal of that point. For example, the normal calculator 118 may calculate a difference between a neighboring pixel lifted to a 3D space and the center pixel lifted to the 3D space (e.g., Π(v)−Π(u) as given in Equation (3)). The covariance matrix may be calculated based on the difference (e.g., as given in Equation (3)). In some configurations, calculating the covariance matrix may be based on the difference and a transpose of the difference (e.g., a product of the difference and the transpose of the difference). In some examples, calculating the covariance matrix may include calculating a sum of products of the difference and the transpose of the difference over a set of neighboring pixels. In some configurations, the difference calculation and/or the covariance matrix calculation may not include a mean or average or may not include determining a mean or average.

In some configurations, calculating the surface normal corresponding to the center pixel based on the 2D subset may include determining an eigenvector of the covariance matrix. The surface normal (e.g., surface normal corresponding to the center pixel) may be the eigenvector associated with a smallest eigenvalue of the covariance matrix. In some examples, determining the eigenvector may include performing principal component analysis (PCA) or singular value decomposition (SVD) on the covariance matrix, which may provide or indicate the eigenvectors and/or eigenvalues of the covariance matrix. In some configurations, calculating the normal may include cloud fitting a local plane to pixels within the 2D subset. For example, cloud fitting the local plane may be performed by calculating the covariance matrix and/or calculating the normal as described.

In some configurations, the subset extractor 116 may extract a set of 2D subsets of the depth image. For example, the set of 2D subsets may correspond to foreground pixels of the depth image. The normal calculator 118 may calculate a set of normals corresponding to the set of 2D subsets. For example, the normal calculator 118 may calculate a normal for each foreground pixel in the depth image.

In some configurations of the systems and methods disclosed herein, the time complexity of extracting the set of 2D subsets and calculating the set of normals is on an order of a number of the 2D subsets multiplied by a time complexity for calculating the normal (e.g., a time complexity of calculating an eigenvector). For example, the time complexity may include a time complexity for calculating the normal (e.g., eigenvector) from the covariance matrix. For instance, the time complexity may be expressed as O(NM^{ω}), where O denotes big O notation, N is a number of 2D subsets, M is a number of pixels in each of the 2D subsets, ω is a number (e.g., a fixed number between 2-3), and M^{ω} is a time complexity of calculating the eigenvector (e.g., performing PCA or SVD). In some configurations, extracting the 2D subsets and calculating the set of normals may avoid the complexity of extracting local neighborhoods from the 3D point cloud.

In some configurations, the processor 112 may apply a guided filter (or other de-noising technique) to the depth image and then extract the normal from the de-noised depth image. For example, the guided filter or other de-noising technique may be applied before extracting the normal. The guided filter or other de-noising technique may reduce noise in the depth image to improve accuracy for the extracted normal(s).

In some configurations, the processor 112 may include and/or implement a registration module 120. As used herein, a “module” may be implemented in hardware or in a combination of hardware and software. The registration module 120 may register two or more depth images based on the normal or set of normals. In some configurations, multiple depth images may be obtained (e.g., captured and/or received). For instance, a first depth image may be captured by a first depth sensor and a second depth image may be captured by a second depth sensor. Alternatively, a first depth image may be captured by a first depth sensor and a second depth image may be captured by the first depth sensor at another time (e.g., before or after the first depth image). The registration module 120 may register the first depth image and the second depth image. For example, the registration module 120 may register the first depth image (e.g., a 2D depth image) with a second depth image (e.g., another 2D depth image) by minimizing a point to plane distance. For example, the registration module 120 may perform registration by minimizing the point-to-plane distance with respect to a transformation or warping between the two or more depth images. In some approaches, the point to plane distance for associated pixels may be expressed in accordance with Equation (4).

T*=arg min_{T}Σᵢ(T{Π(uᵢ^{s})}−Π(uᵢ^{t}))nᵢ^{t} (4)

In Equation (4), i is a pixel index, uᵢ^{s} is a pixel of a reference depth image, uᵢ^{t} is the associated pixel of a target depth image, and nᵢ^{t} is the normal of that pixel. T is the transformation between the point cloud of the reference image to the point cloud of the target image.

In some configurations, the processor 112 may include and/or implement a surface generator 122. The surface generator 122 may generate a surface based on the normal corresponding to the center pixel. For example, the surface generator 122 may generate a surface based on the set of normals. Each normal may indicate an orientation of the surface at each pixel. In some approaches, the surface generator 122 may render the surface on the display 132. For example, the surface generator 122 may generate optical pixel data (e.g., an image) representing the surface, which may be presented on the display 132.

In some configurations, the surface generator 122 may determine and/or present shading for the surface. For example, the surface generator 122 may determine shading for the surface, where the color is proportional to an angle between the surface normal and the incoming light direction. In some approaches the shading may be determined in accordance with Equation (5).

c(u)αcos(nᵤ·n_{light}) (5)

In Equation (5), c(u) is a color associated with a pixel without shading, α is a scale number, nᵤ is the normal at pixel u, and n_{light} is the incoming light direction. In some configurations, the surface with the determined shading may be presented on the display 132. In some configurations, the electronic device 102 may send the normal, the set of normals, a generated surface, a rendering of the surface, and/or shading to another device (via the communication interface(s) 108, for example).

In some configurations, one or more of the components or elements described in connection with FIG. 1 may be combined and/or divided. For example, the subset extractor 116 and/or normal calculator 118 may be combined into an element that performs the functions of the subset extractor 116 and normal calculator 118. In another example, the subset extractor 116 and/or normal calculator 118 may be divided into a number of separate components or elements that perform a subset of the functions associated with the subset extractor 116 and/or normal calculator 118.

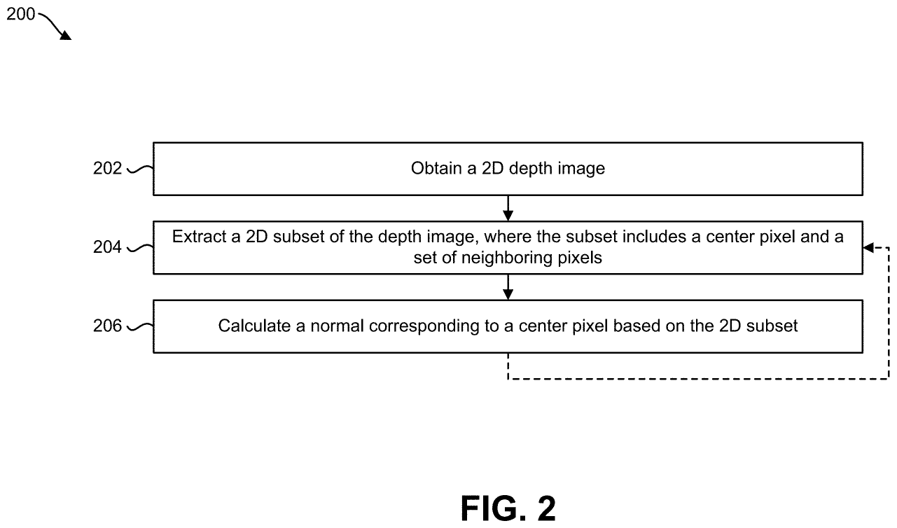

FIG. 2 is a flow diagram illustrating one configuration of a method 200 for extracting a surface normal from a depth image. The method 200 may be performed by the electronic device 102 described in connection with FIG. 1. The electronic device 102 may obtain 202 a 2D depth image. This may be accomplished as described in connection with FIG. 1. For example, the electronic device 102 may obtain sensor data (e.g., receive one or more depth images from a depth sensor) and/or may receive one or more depth images from another device.

The electronic device 102 may extract 204 a 2D subset of the depth image. The subset may include a center pixel and a set of neighboring pixels. This may be accomplished as described in connection with FIG. 1. For example, the electronic device 102 may select a subset with a center pixel and a number of neighboring pixels within a range from the center pixel. In some configurations, the electronic device 102 may utilize a sliding window to select the 2D subset.

The electronic device 102 may calculate 206 a normal corresponding to a center pixel based on the 2D subset. This may be accomplished as described in connection with FIG. 1. For example, the electronic device 102 may calculate a covariance matrix based on the 2D subset and may determine an eigenvector of the covariance matrix with a smallest associated eigenvalue (e.g., the normal).

In some configurations, the electronic device 102 may repeat one or more steps or operations of the method 200. For example, the electronic device 102 may extract 204 a set of 2D subsets and/or may calculate 206 a set of normals.

In some configurations, the electronic device 102 may register the 2D depth image with one or more other depth images based on the normal or set of normals. This may be accomplished as described in connection with FIG. 1. In some configurations, the electronic device 102 may apply (e.g., first apply) guided filtering on the depth image as described in connection with FIG. 1. In some configurations, the electronic device 102 may generate a surface based on the normal or set of normals as described in connection with FIG. 1. In some configurations, the electronic device 102 may send the surface to another device, determine shading for the surface, render the surface, and/or present the surface on a display as described in connection with FIG. 1.

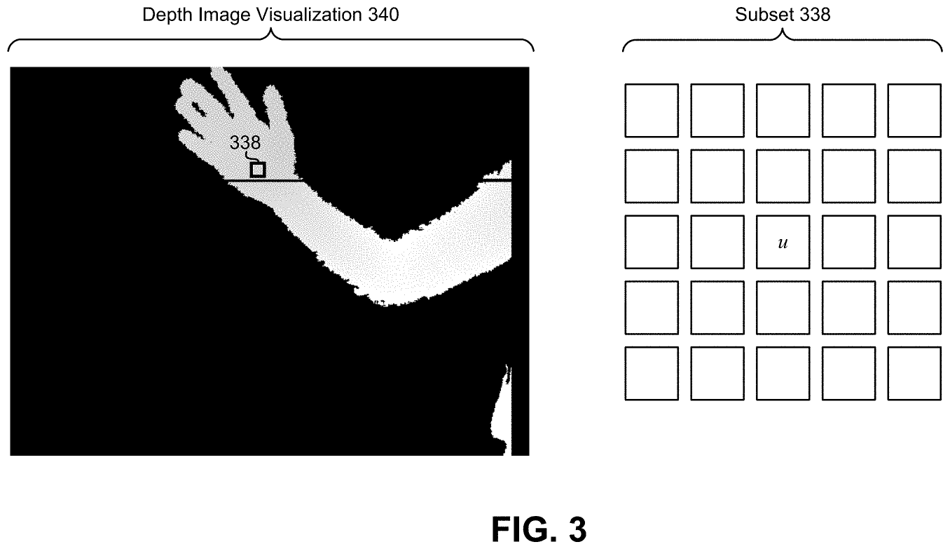

FIG. 3 is a diagram illustrating an example of 2D subset 338 of a depth image. In this example, the depth image visualization 340 is a visualization of a depth image, where the black portions represent background pixels and the white or gray portions represent foreground pixels in a depth image. As described herein, a 2D subset 338 may be extracted from a depth image. The 2D subset 338 may include a center pixel, which is denoted as u in FIG. 3. The other pixels in the 2D subset 338 are neighboring pixels in this example. In some configurations, the 2D subset 338 may be extracted using a window or sliding window. It should be noted that while the example of the 2D subset 338 includes pixels within a range of ±2 pixels from the center pixel u, other sizes of subsets (and/or sliding windows) may be utilized in accordance with the systems and methods disclosed herein.

FIG. 4 is a flow diagram illustrating one configuration of another method 400 for extracting a surface normal from a depth image. The method 400 may be performed by the electronic device 102 described in connection with FIG. 1. The electronic device 102 may obtain 402 a 2D depth image. This may be accomplished as described in connection with FIG. 1.

The electronic device 102 may extract 404 a 2D subset of the depth image. The subset may include a center pixel and a set of neighboring pixels. This may be accomplished as described in connection with FIG. 1.

The electronic device 102 may remove 406 any background pixel from the 2D subset to produce a trimmed 2D subset. This may be accomplished as described in connection with FIG. 1. For example, the electronic device 102 may determine whether there are one or more background pixels included in the 2D subset. In some cases, a background pixel may be indicated (by a depth sensor, for example) with a particular value or indicator. In some configurations, a background pixel may be indicated by a value of 0. The electronic device 102 may remove 406 any pixel with a value of 0 from the 2D subset in some approaches. Additionally or alternatively, the electronic device 102 may apply a masking function to the 2D subset to remove any background pixel from the 2D subset.

The electronic device 102 may calculate 408 a normal corresponding to a center pixel based on the trimmed 2D subset. This may be accomplished as described in connection with FIG. 1. For example, the electronic device 102 may calculate a covariance matrix based on the trimmed 2D subset and may determine an eigenvector of the covariance matrix with a smallest associated eigenvalue (e.g., the normal).

FIG. 5 is a diagram illustrating another example of 2D subset 544 of a depth image. In this example, the depth image visualization 542 is a visualization of a depth image, where the black portions represent background pixels and the white or gray portions represent foreground pixels in a depth image. As described herein, a 2D subset 544 may be extracted from a depth image. The 2D subset 544 may include a center pixel, which is denoted as u in FIG. 3. The other pixels in the 2D subset 544 are neighboring pixels in this example. In the 2D subset, foreground pixels are denoted by “F” and background pixels are denoted by “B.” A trimmed subset 546 may be utilized along the boundary of an object to avoid any error introduced by the adjacent background. In some configurations, the 2D subset 544 (e.g., window) may be automatically trimmed with a masking function. An example of a masking function G is given in Equation (6).

$$G ( p ) = \{ \begin{matrix}1 & D ( p ) > ɛ \\ 0 & D ( p ) \leq ɛ\end{matrix} \} \qquad ( 6 )$$

In Equation (6), G is the masking function, p is a pixel, D is the depth image (or subset), and ε is a mask threshold. For example, the mask threshold may be 0, such that if any pixel has a value of 0, the masking function will remove that pixel from the subset 544 to produce the trimmed subset 546. Or, any pixel that has a value of greater than 0 will be maintained in the trimmed subset 546. In some configurations, the masking function may be applied in accordance with Equation (7) or Equation (8).

CV=Σ_{v∈η(u)∩G(v)=1}(Π(v)−Π(u))(Π(v)−Π(u))′ (7)

CV=Σ_{v∈η(u)}G(v)(Π(v)−Π(u))(Π(v)−Π(u))′ (8)

Equation (7) illustrates an approach that applies the masking function (G) as a selection condition. Equation (8) illustrates an approach that applies the masking function (G) by multiplying the masking function to the corresponding difference term.

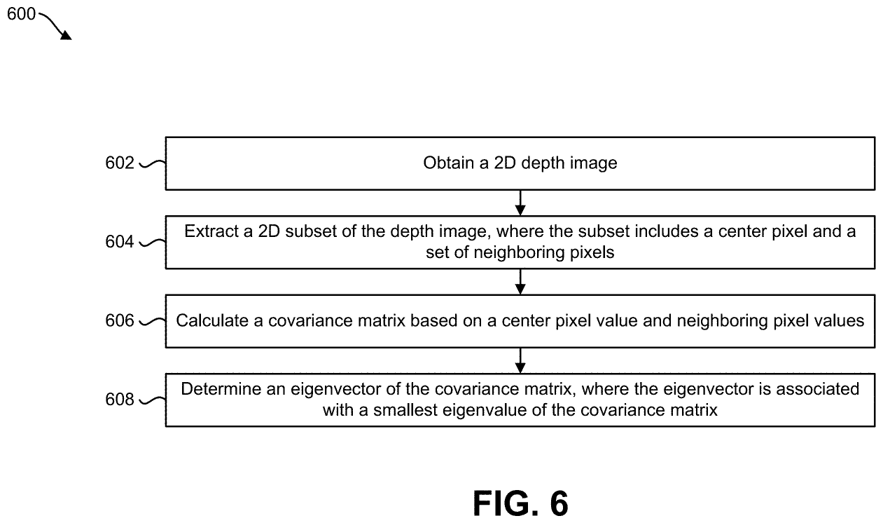

FIG. 6 is a flow diagram illustrating another configuration of a method 600 for extracting a surface normal from a depth image. The method 600 may be performed by the electronic device 102 described in connection with FIG. 1. The electronic device 102 may obtain 602 a 2D depth image. This may be accomplished as described in connection with FIG. 1.

The electronic device 102 may extract 604 a 2D subset of the depth image. The subset may include a center pixel and a set of neighboring pixels. This may be accomplished as described in connection with FIG. 1.

The electronic device 102 may calculate 606 a covariance matrix based on a center pixel value and neighboring pixel values. This may be accomplished as described in connection with FIG. 1. For example, the electronic device 102 may lift the center pixel and neighboring pixels into a 3D space and calculate the covariance matrix based on the lifted center pixel value and the lifted neighboring pixel values. In some configurations, calculating 606 the covariance matrix may be performed in accordance with Equations (1)-(3).

The electronic device 102 may determine 608 an eigenvector of the covariance matrix, where the eigenvector is associated with a smallest eigenvalue of the covariance matrix. This may be accomplished as described in connection with FIG. 1. For example, the electronic device 102 may determine which eigenvalue of the covariance matrix is the minimum eigenvalue. The electronic device 102 may determine the eigenvector associated with the smallest eigenvalue. The resulting eigenvector may be the normal corresponding to the center pixel.

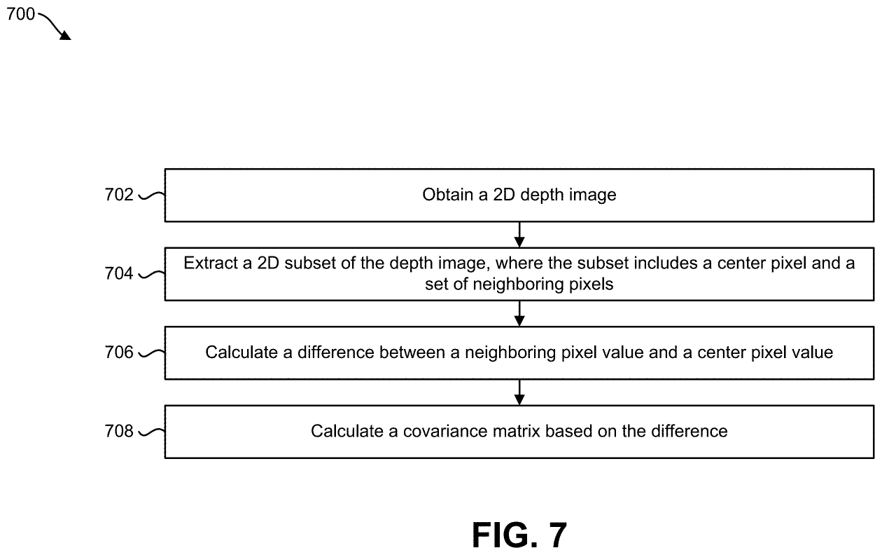

FIG. 7 is a flow diagram illustrating another configuration of a method 700 for extracting a surface normal from a depth image. The method 700 may be performed by the electronic device 102 described in connection with FIG. 1. The electronic device 102 may obtain 702 a 2D depth image. This may be accomplished as described in connection with FIG. 1.

The electronic device 102 may extract 704 a 2D subset of the depth image. The subset may include a center pixel and a set of neighboring pixels. This may be accomplished as described in connection with FIG. 1.

The electronic device 102 may calculate 706 a difference between a neighboring pixel value and a center pixel value. This may be accomplished as described in connection with FIG. 1. For example, the electronic device 102 may lift the center pixel and a neighboring pixel into a 3D space and subtract the center pixel value from the neighboring pixel value. This approach may provide sharpening. In some configurations, calculating 706 the difference may be performed in accordance with Π(v)−Π(u).

The electronic device 102 may calculate 708 a covariance matrix based on the difference. This may be accomplished as described in connection with FIG. 1. For example, the electronic device 102 may calculate the covariance matrix in accordance with Equation (3).

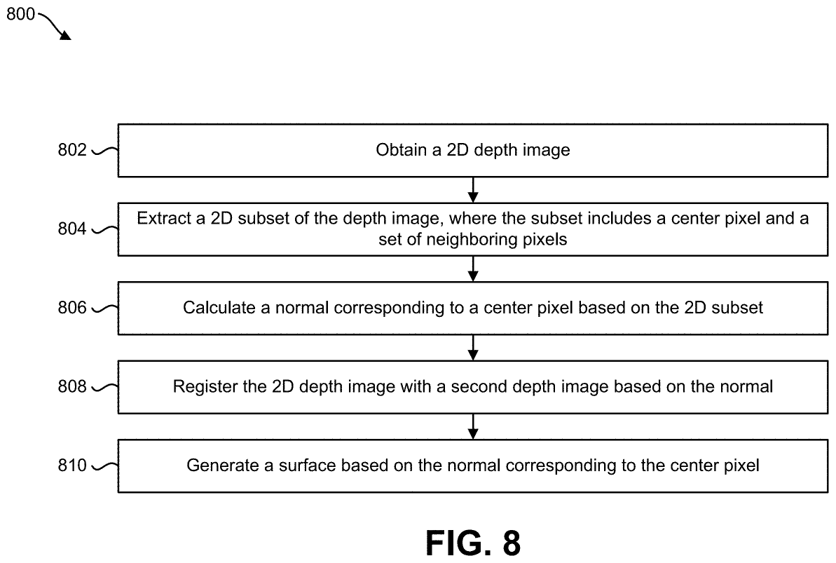

FIG. 8 is a flow diagram illustrating another configuration of a method 800 for extracting a surface normal from a depth image. The method 800 may be performed by the electronic device 102 described in connection with FIG. 1. The electronic device 102 may obtain 802 a 2D depth image. This may be accomplished as described in connection with FIG. 1.

The electronic device 102 may extract 804 a 2D subset of the depth image. The subset may include a center pixel and a set of neighboring pixels. This may be accomplished as described in connection with FIG. 1.

The electronic device 102 may calculate 806 a normal corresponding to a center pixel based on the 2D subset. This may be accomplished as described in connection with FIG. 1.

In some configurations, the electronic device 102 may register 808 the 2D depth image with a second depth image based on the normal or set of normals. This may be accomplished as described in connection with FIG. 1. For example, the electronic device 102 may minimize a point to plane distance based on the normal in order to register 808 the 2D depth image with a second depth image.

In some configurations, the electronic device 102 may generate 810 a surface based on the normal (or set of normals). This may be accomplished as described in connection with FIG. 1. In some configurations, the electronic device 102 may send the surface to another device, determine shading for the surface, render the surface, and/or present the surface on a display as described in connection with FIG. 1. For example, the electronic device 102 may present a 3D model and/or animation based on the surface. In some configurations, the surface may be presented in a virtual reality (VR) or augmented reality (AR) environment on one or more displays. In some configurations, a vehicle or robot may utilize the surface to navigate or plan a route (e.g., avoid collisions, park a vehicle, etc.). In some configurations, the electronic device 102 may present the surface in a 3D rendering for navigation and/or mapping.

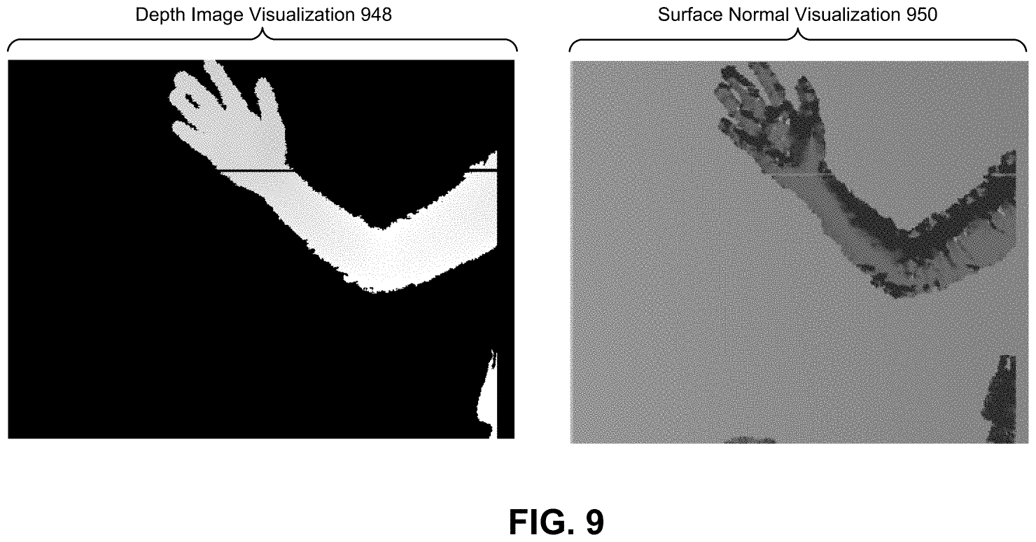

FIG. 9 is a diagram illustrating an example of a depth image visualization 948 and a surface normal visualization 950. In this example, the depth image visualization 948 is a visualization of a depth image, where the black portions represent background pixels and the white or gray portions represent foreground pixels in a depth image. The surface normal visualization 950 is an example of a visualization of a set of normals calculated from a depth image in accordance with the systems and methods disclosed herein. As can be observed, the surface normal visualization 950 illustrates the beneficial accuracy of some configurations of the systems and methods disclosed herein. For example, accuracy of surface normal calculation may be achieved while reducing time complexity in accordance with some configurations of the systems and methods disclosed herein.

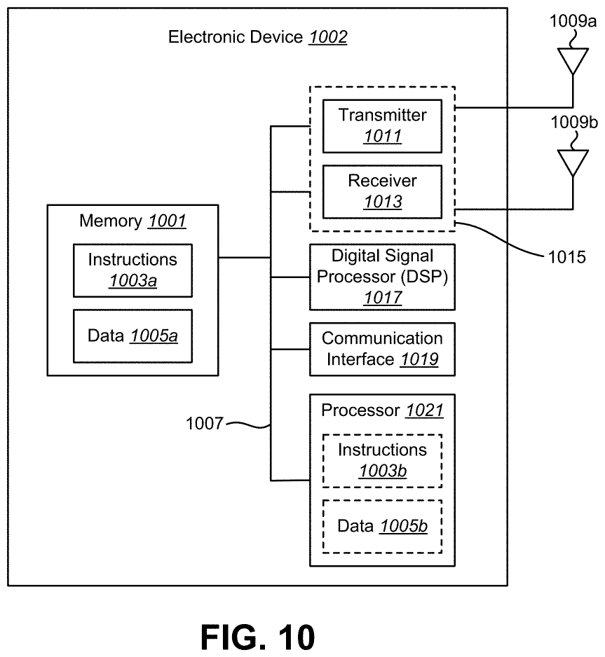

FIG. 10 illustrates certain components that may be included within an electronic device 1002 configured to implement various configurations of the systems and methods disclosed herein. Examples of the electronic device 1002 may include servers, cameras, video camcorders, digital cameras, cellular phones, smart phones, computers (e.g., desktop computers, laptop computers, etc.), tablet devices, media players, televisions, vehicles, automobiles, personal cameras, wearable cameras, virtual reality devices (e.g., headsets), augmented reality devices (e.g., headsets), mixed reality devices (e.g., headsets), action cameras, mounted cameras, connected cameras, robots, aircraft, drones, unmanned aerial vehicles (UAVs), gaming consoles, personal digital assistants (PDAs), etc. The electronic device 1002 may be implemented in accordance with one or more of the electronic devices (e.g., electronic device 102) described herein.

The electronic device 1002 includes a processor 1021. The processor 1021 may be a general purpose single- or multi-chip microprocessor (e.g., an ARM), a special purpose microprocessor (e.g., a digital signal processor (DSP)), a microcontroller, a programmable gate array, etc. The processor 1021 may be referred to as a central processing unit (CPU). Although just a single processor 1021 is shown in the electronic device 1002, in an alternative configuration, a combination of processors (e.g., an ARM and DSP) could be implemented.

The electronic device 1002 also includes memory 1001. The memory 1001 may be any electronic component capable of storing electronic information. The memory 1001 may be embodied as random-access memory (RAM), read-only memory (ROM), magnetic disk storage media, optical storage media, flash memory devices in RAM, on-board memory included with the processor, EPROM memory, EEPROM memory, registers, and so forth, including combinations thereof.

Data 1005a and instructions 1003a may be stored in the memory 1001. The instructions 1003a may be executable by the processor 1021 to implement one or more of the methods, procedures, steps, and/or functions described herein. Executing the instructions 1003a may involve the use of the data 1005a that is stored in the memory 1001. When the processor 1021 executes the instructions 1003, various portions of the instructions 1003b may be loaded onto the processor 1021 and/or various pieces of data 1005b may be loaded onto the processor 1021.

The electronic device 1002 may also include a transmitter 1011 and/or a receiver 1013 to allow transmission and reception of signals to and from the electronic device 1002. The transmitter 1011 and receiver 1013 may be collectively referred to as a transceiver 1015. One or more antennas 1009a-b may be electrically coupled to the transceiver 1015. The electronic device 1002 may also include (not shown) multiple transmitters, multiple receivers, multiple transceivers and/or additional antennas.

The electronic device 1002 may include a digital signal processor (DSP) 1017. The electronic device 1002 may also include a communication interface 1019. The communication interface 1019 may allow and/or enable one or more kinds of input and/or output. For example, the communication interface 1019 may include one or more ports and/or communication devices for linking other devices to the electronic device 1002. In some configurations, the communication interface 1019 may include the transmitter 1011, the receiver 1013, or both (e.g., the transceiver 1015). Additionally or alternatively, the communication interface 1019 may include one or more other interfaces (e.g., touchscreen, keypad, keyboard, microphone, camera, etc.). For example, the communication interface 1019 may enable a user to interact with the electronic device 1002.

The various components of the electronic device 1002 may be coupled together by one or more buses, which may include a power bus, a control signal bus, a status signal bus, a data bus, etc. For the sake of clarity, the various buses are illustrated in FIG. 10 as a bus system 1007.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may comprise RAM, ROM, EEPROM, Compact Disc Read-Only Memory (CD-ROM) or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk, and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed, or computed by the computing device or processor. As used herein, the term “code” may refer to software, instructions, code, or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio and microwave, then the coaxial cable, fiber optic cable, twisted pair, DSL, or wireless technologies such as infrared, radio and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims. It should also be noted that one or more steps and/or actions may be added to the method(s) and/or omitted from the method(s) in some configurations of the systems and methods disclosed herein.

Further, it should be appreciated that modules and/or other appropriate means for performing the methods and techniques described herein, can be downloaded, and/or otherwise obtained by a device. For example, a device may be coupled to a server to facilitate the transfer of means for performing the methods described herein. Alternatively, various methods described herein can be provided via a storage means (e.g., random access memory (RAM), read-only memory (ROM), a physical storage medium such as a compact disc (CD) or floppy disk, etc.), such that a device may obtain the various methods upon coupling or providing the storage means to the device.

As used herein, the term “and/or” should be interpreted to mean one or more items. For example, the phrase “A, B, and/or C” should be interpreted to mean any of: only A, only B, only C, A and B (but not C), B and C (but not A), A and C (but not B), or all of A, B, and C. As used herein, the phrase “at least one of” should be interpreted to mean one or more items. For example, the phrase “at least one of A, B, and C” or the phrase “at least one of A, B, or C” should be interpreted to mean any of: only A, only B, only C, A and B (but not C), B and C (but not A), A and C (but not B), or all of A, B, and C. As used herein, the phrase “one or more of” should be interpreted to mean one or more items. For example, the phrase “one or more of A, B, and C” or the phrase “one or more of A, B, or C” should be interpreted to mean any of: only A, only B, only C, A and B (but not C), B and C (but not A), A and C (but not B), or all of A, B, and C.

It is to be understood that the claims are not limited to the precise configuration and components illustrated above. Various modifications, changes, and variations may be made in the arrangement, operation, and details of the systems, methods, and electronic device described herein without departing from the scope of the claims.

What is claimed is:

1. A method performed by an electronic device, comprising:
obtaining a two-dimensional (2D) depth image;
extracting a 2D subset of the depth image, wherein the 2D subset includes a center pixel and a set of neighboring pixels; and
calculating a normal corresponding to the center pixel by calculating a covariance matrix based on the 2D subset.

2. The method of claim 1, further comprising removing one or more background pixels from the 2D subset to produce a trimmed 2D subset, wherein the normal is calculated based on the trimmed 2D subset.

3. The method of claim 1, wherein calculating the normal comprises performing sharpening by calculating a difference between a neighboring pixel value and a center pixel value and calculating the covariance matrix based on the difference.

4. The method of claim 3, wherein calculating the covariance matrix is based on the difference and a transpose of the difference.

5. The method of claim 1, wherein calculating the normal corresponding to the center pixel comprises determining an eigenvector of the covariance matrix, wherein the eigenvector is associated with a smallest eigenvalue of the covariance matrix.

6. The method of claim 1, further comprising:
extracting a set of 2D subsets of the depth image that includes the 2D subset, wherein the set of 2D subsets corresponds to foreground pixels of the depth image, and
calculating a set of normals corresponding to the set of 2D subsets.

7. The method of claim 6, wherein a time complexity of extracting the set of 2D subsets and calculating the set of normals is an order of a number of the 2D subsets multiplied by a time complexity of calculating an eigenvector.

8. The method of claim 1, wherein calculating the normal corresponding to the center pixel comprises lifting the 2D subset into a three-dimensional (3D) space.

9. The method of claim 1, further comprising generating a surface based on the normal corresponding to the center pixel.

10. The method of claim 1, further comprising registering the 2D depth image with a second depth image based on the normal corresponding to the center pixel.

11. An electronic device, comprising:
a memory;
a processor coupled to the memory, wherein the processor is configured to:
obtain a two-dimensional (2D) depth image;
extract a 2D subset of the depth image, wherein the 2D subset includes a center pixel and a set of neighboring pixels; and
calculate a normal corresponding to the center pixel by calculating a covariance matrix based on the 2D subset.

12. The electronic device of claim 11, wherein the processor is configured to remove one or more background pixels from the 2D subset to produce a trimmed 2D subset, and wherein the processor is configured to calculate the normal based on the trimmed 2D subset.

13. The electronic device of claim 11, wherein the processor is configured to perform sharpening by calculating a difference between a neighboring pixel value and a center pixel value and by calculating the covariance matrix based on the difference.

14. The electronic device of claim 13, wherein the processor is configured to calculate the covariance matrix based on the difference and a transpose of the difference.

15. The electronic device of claim 11, wherein the processor is configured to calculate the normal corresponding to the center pixel by determining an eigenvector of the covariance matrix, wherein the eigenvector is associated with a smallest eigenvalue of the covariance matrix.

16. The electronic device of claim 11, wherein the processor is configured to:
extract a set of 2D subsets of the depth image that includes the 2D subset, wherein the set of 2D subsets corresponds to foreground pixels of the depth image, and
calculate a set of normals corresponding to the set of 2D subsets.

17. The electronic device of claim 16, wherein a time complexity of extracting the set of 2D subsets and calculating the set of normals is an order of a number of the 2D subsets multiplied by a time complexity of calculating an eigenvector.

18. The electronic device of claim 11, wherein the processor is configured to calculate the normal corresponding to the center pixel by lifting the 2D subset into a three-dimensional (3D) space.

19. The electronic device of claim 11, wherein the processor is configured to generate a surface based on the normal corresponding to the center pixel.

20. The electronic device of claim 11, wherein the processor is configured to register the 2D depth image with a second depth image based on the normal corresponding to the center pixel.

21. A non-transitory tangible computer-readable medium storing computer executable code, comprising:
code for causing an electronic device to obtain a two-dimensional (2D) depth image;
code for causing the electronic device to extract a 2D subset of the depth image, wherein the 2D subset includes a center pixel and a set of neighboring pixels; and
code for causing the electronic device to calculate a normal corresponding to the center pixel by calculating a covariance matrix based on the 2D subset.

22. The computer-readable medium of claim 21, further comprising code for causing the electronic device to remove one or more background pixels from the 2D subset to produce a trimmed 2D subset, and to calculate the normal based on the trimmed 2D subset.

23. The computer-readable medium of claim 21, further comprising code for causing the electronic device to perform sharpening by calculating a difference between a neighboring pixel value and a center pixel value and by calculating the covariance matrix based on the difference.

24. The computer-readable medium of claim 21, further comprising code for causing the electronic device to calculate the normal corresponding to the center pixel by determining an eigenvector of the covariance matrix, wherein the eigenvector is associated with a smallest eigenvalue of the covariance matrix.

25. The computer-readable medium of claim 21, further comprising code for causing the electronic device to:
extract a set of 2D subsets of the depth image that includes the 2D subset, wherein the set of 2D subsets corresponds to foreground pixels of the depth image, and
calculate a set of normals corresponding to the set of 2D subsets.

26. An apparatus, comprising:
means for obtaining a two-dimensional (2D) depth image;
means for extracting a 2D subset of the depth image, wherein the 2D subset includes a center pixel and a set of neighboring pixels; and
means for calculating a normal corresponding to the center pixel by calculating a covariance matrix based on the 2D subset.

27. The apparatus of claim 26, further comprising means for removing one or more background pixels from the 2D subset to produce a trimmed 2D subset, wherein the means for calculating the normal is based on the trimmed 2D subset.

28. The apparatus of claim 26, wherein the means for calculating the normal comprises means for performing sharpening by calculating a difference between a neighboring pixel value and a center pixel value and by calculating the covariance matrix based on the difference.

29. The apparatus of claim 26, wherein the means for calculating the normal corresponding to the center pixel comprises means for determining an eigenvector of the covariance matrix, wherein the eigenvector is associated with a smallest eigenvalue of the covariance matrix.

30. The apparatus of claim 26, further comprising:
means for extracting a set of 2D subsets of the depth image that includes the 2D subset, wherein the set of 2D subsets corresponds to foreground pixels of the depth image, and
means for calculating a set of normals corresponding to the set of 2D subsets.
